(19) United States
(12) Patent Application Publication
(10) Pub. No.: US 2005/0249964 A1
(43) Pub. Date: Nov. 10, 2005

(54) Multilayer sliding member

(75) Inventors: Hideyuki Nakajima, Inuyama (JP); Takahiro Niwa, Inuyama (JP); Nobutaka Hiramatsu, Inuyama (JP)

Correspondence Address: BROWDY AND NEIMARK, P.L.L.C.;624 NINTH STREET, NW, SUITE 300, WASHINGTON, DC, 20001-5303, US

(73) Assignee: Daido Metal Co. Ltd., Nagoya (JP)

(21) Appl. No.: 10/979,261

(22) Filed: Nov. 3, 2004

(30) Foreign Application Priority Data
May 10, 2004 (JP) 2004-140388

(51) Int. Cl. B32B 27/00; B32B 15/08

(52) U.S. Cl. 428/553; 428/422; 428/458; 428/327; 384/908; 384/909; 428/626

(57) ABSTRACT

A multilayer sliding member is provided that contains no lead but has superior friction and abrasion properties under the conditions of high PV values and can be used suitably in dry lubrication environments. The multilayer sliding member includes: a porous metal layer that is formed on a back metal; and a sliding layer that is formed by impregnating and coating the porous metal layer, wherein the sliding layer includes 1 to 25% by volume of an oxybenzoyl polyester resin, 1 to 15% by volume of a phosphate, 1 to 20% by volume of barium sulfate, and polytetrafluoroethylene resin. The oxybenzoyl polyester resin (POB) improves the strength and abrasion resistance of the sliding material, and the synergistic effect of the phosphate and barium sulfate facilitates the transfer of PTFE to a counter material during sliding, so that the coefficient of friction can be decreased and the abrasion resistance can be improved.

### BACKGROUND OF THE INVENTION

The present invention relates to a multilayer sliding member comprising a porous metal layer that is formed on a back metal and a sliding layer that is formed by impregnating and coating the porous metal layer.

### PRIOR ART

Polytetrafluoroethylene resin (hereinafter referred to as “PTFE”) is used for sliding members such as bearings because it has a low coefficient of friction and a superior self-lubricating property. However, it does not have a sufficient abrasion resistance, so that PTFE filled with lead has been used as the sliding member. Lead has the effect of improving abrasion resistance of PTFE as well as facilitating the transfer of PTFE to the counter material during sliding. These effects make the sliding of the sliding material and the counter material become a mutual sliding of a PTFE surface of the sliding material and a transferred PTFE film on the counter material, which is more superior in the coefficient of friction and abrasion resistance. However, recent measures for environmental problems require sliding materials without lead. Therefore, sliding materials, to which synthetic resins, solid lubricants, and inorganic compounds are added instead of lead, have been used. This type of sliding material is publicly known in JP-A-2000-319472.

JP-A-2000-319472 discloses a sliding material, in which barium sulfate, phosphate, and polyimide resin are added to PTFE. Recently, however, the PV value (the product of load P and speed V) becomes higher in use conditions for various applications, so that further improvements in friction and abrasion properties have been required. The present invention is made in view of the above circumstances, and it is an object of the present invention to provide a multilayer sliding member that has superior friction and abrasion properties under the conditions of high PV values without adding lead and can be used suitably in dry lubrication environments.

### SUMMARY OF THE INVENTION

According to the present invention, the following sliding members are provided.

(1) A multilayer sliding member comprising:
a back metal;
a porous metal layer being formed on the back metal; and
a sliding layer impregnated into and coated on the porous metal layer, the sliding layer comprising 1 to 25% by volume of an oxybenzoyl polyester resin, 1 to 15% by volume of a phosphate, 1 to 20% by volume of barium sulfate, and a polytetrafluoroethylene resin.

(2) The multilayer sliding member according to aspect (1), wherein an average particle size of the oxybenzoyl polyester resin is from 5 to 30 μm.

(3) The multilayer sliding member according to aspect (1) or (2), wherein the polytetrafluoroethylene resin has a maximum reduction ratio of more than 1,000.

(4) The multilayer sliding member according to aspect (1), (2) or (3), wherein the phosphate comprises at least one selected from the group consisting of calcium phosphate, calcium pyrophosphate, magnesium phosphate, and magnesium pyrophosphate.

(5) The multilayer sliding member according to aspect (1), (2), (3) or (4), wherein the sliding layer further contains 10% or less by volume of graphite or/and molybdenum disulfide.

(6) The multilayer sliding member according to aspect (1), (2), (3), (4) or (5), wherein the sliding layer is substantially free of lead.

In aspect (1) of the present invention, a multilayer sliding member comprises: a porous metal layer that is formed on a back metal; and a sliding layer that is formed by impregnating and coating the porous metal layer, wherein the sliding layer comprises 1 to 25% by volume of an oxybenzoyl polyester resin, 1 to 15% by volume of a phosphate, 1 to 20% by volume of barium sulfate, and polytetrafluoroethylene resin.

Oxybenzoyl polyester resin (hereinafter referred to as “POB”) is a thermoplastic resin generally called liquid crystal polymer and has the effect of improving the strength and abrasion resistance of the sliding material. The content of POB should be 1 to 25% by volume and preferably 10 to 20% by volume. If the content of POB is less than 1% by volume, the effect of improving the abrasion resistance is not achieved. If the content of POB is more than 25% by volume, the structure of PTFE, which is the base resin, becomes brittle, so that the abrasion resistance decreases.

When the average particle size of POB is 5 to 30 μm as specified in aspect (2), preferably 5 to 25 μm, the abrasion resistance improves. If the average particle size of POB is less than 5 μm, the effect of improving the abrasion resistance is not achieved. If the average particle size of POB is more than 30 μm, dropping off or the like may occur during sliding, which increases abrasion.

The phosphate has the effect of improving the abrasion resistance and the effect of facilitating the transfer of PTFE to the counter material during sliding. These effects make the sliding of the sliding material and the counter material become a mutual sliding of a PTFE surface of the sliding material and a transferred PTFE film on the counter material, which is more superior in the coefficient of friction and abrasion resistance. The phosphate can be selected from calcium phosphate, calcium pyrophosphate, magnesium phosphate, and magnesium pyrophosphate. The content of phosphate is 1 to 15% by volume and preferably 1 to 10% by volume. If the content of phosphate is less than 1% by volume, the effects are not achieved. If the content of phosphate is more than 15% by volume, the transfer of PTFE to the counter material becomes excessive, so that the friction and abrasion properties decrease.

Further, by simultaneously using barium sulfate and phosphate, the abrasion resistance improves due to their synergistic effect. The content of barium sulfate is 1 to 20% by volume and preferably 5 to 20% by volume. If the content of barium sulfate is less than 1% by volume, the effect is not achieved. If the content of barium sulfate is more than 20% by volume, the structure of PTFE, which is the base resin, becomes brittle, so that the abrasion resistance decreases.

As specified in aspect (3), it is preferable that PTFE, which is the base resin, has a maximum reduction ratio (hereinafter referred to as “R.R.”) of more than 1,000. R.R. indicates the degree of fiberization that occurs when pressure or the like is applied to PTFE. As the value of R.R. becomes smaller, fiberization occurs more easily. In the present invention, when R.R. is 1,000 or less, a stable structure is not obtained due to this fiberization. This fiberization occurs in the step of mixing PTFE with various fillers and the step of impregnating and coating the porous metal layer. As a result, in the step of impregnating and coating the porous metal layer, the non-impregnation and collapsing of the porous metal layer occur, which leads to a decrease in the adhesion due to the anchor effect. This leads to the rapid exposure of the porous metal layer during sliding, which decreases the friction and abrasion properties. On the other hand, when R.R. is more than 1,000, fiberization is restrained in the step of mixing with various fillers and the step of impregnating and coating, so that a stable structure is obtained. In other words, the non-impregnation and collapsing of the porous metal layer do not occur, so that sufficient adhesion due to the anchor effect is obtained. Therefore, the rapid exposure of the porous metal layer does not occur during sliding, which provides superior friction and abrasion properties.

Further, as specified in aspect (5), when the sliding layer further contains 10% or less by volume of graphite and/or molybdenum disulfide, the abrasion resistance improves and a stable low coefficient of friction is obtained. If the content of graphite and/or molybdenum disulfide is more than 10% by volume, the structure of PTFE, which is the base resin, becomes brittle, so that the abrasion resistance tends to decrease.

In the present invention, POB improves the strength and abrasion resistance of the sliding material, and the synergistic effect of phosphate and barium sulfate facilitates the transfer of PTFE to the counter material during sliding, so that the coefficient of friction can be decreased and the abrasion resistance can be improved. Specifically, by using POB having an average particle size of 5 to 30 μm and PTFE, which is the base resin, having a R.R. of more than 1,000, the friction and abrasion properties can be further improved. In addition, by further adding graphite and/or molybdenum disulfide, the abrasion resistance improves and a low coefficient of friction is maintained.

### PREFERRED EMBODIMENTS OF THE INVENTION

The embodiment of the present invention is described below. The multilayer sliding member used in this embodiment is those used for a sliding member for a bearing that supports the rotor of the rotary machine of automobile parts, OA equipment, and the like. The multilayer sliding member is formed by sequentially laminating a back metal, a porous metal layer, and a sliding layer, as is well known. The back metal is made of steel, and the porous metal layer is formed by spreading and sintering a copper alloy powder on a surface of this back metal.

The sliding layer is formed by adding to PTFE 1 to 25% by volume of POB, 1 to 15% by volume of phosphate, and 1 to 20% by volume of barium sulfate, and further containing 10% or less by volume of graphite and/or molybdenum disulfide as required. POB improves the strength and abrasion resistance of the sliding material, and the synergistic effect of phosphate and barium sulfate facilitates the transfer of PTFE to the counter material during sliding, so that the coefficient of friction can be decreased and the abrasion resistance can be improved. Specifically, by using POB having an average particle size of 5 to 30 μm and PTFE, which is the base resin, having a R.R. of more than 1,000, the friction and abrasion properties can be further improved. In addition, by further adding graphite and/or molybdenum disulfide as a solid lubricant, the abrasion resistance improves and a low coefficient of friction is maintained. In the sliding layer, it is desirable to adjust the content of other additives so that PTFE as the base resin is at least 55% by volume.

In the manufacture of the multilayer sliding member that is constituted as described above, a sliding composition for impregnation and coating is obtained by wet mixing a fine powder of PTFE, a predetermined amount of various additives described in Table 2, and a petroleum-derived auxiliary agent. A porous metal layer that is previously formed on a back metal is impregnated and coated with this composition, and the PTFE is sintered at a temperature of 340 to 400° C.

Next, the results of a test that was carried out by making a test piece of a bushing having an inner size of 20 mm and a width of 20 mm from the multilayer sliding member, in which the sliding layer of the above composition is formed, are described with reference to Tables 1 and 2. Table 1 shows test description (test conditions), and the test was carried out at a shaft rotation speed of 6 m/min, under a load of 10 MPa, in a dry lubrication environment, with a shaft material, which is the counter material, being JIS S55C and having a hardness of 700 to 800 Hv and a roughness of Rmax 1.5 μm or less, for a test period of 100 hours.

TABLE 1
Test Description: Bushing Test

| Item | Test conditions | Unit |
|---|---|---|
| Speed | 6 | m/min |
| Load | 10 | MPa |
| Lubrication | Dry | — |
| Shaft material | JIS S55C | — |
| Hardness | 700˜800 | Hv |
| Roughness | 1.5 or less | Rmax μm |
| Test period | 100 | Hr |

Commercially available materials can be used for each composition that constitutes the sliding layer of the multilayer sliding member according to this embodiment. POLYFLON (trade name) F 104 (R.R. ≧1,000) and POLYFLON F 207 (R.R. >1,000) from Daikin Industries, Ltd. were used as PTFE. POB having an average particle size of 5 to 25 μm and barium sulfate having sedimentation property were used.

Examples 1 to 11 that were made as described above and Comparative Examples 1 to 5 that were made with compositions similar to those of Examples 1 to 11 were tested according to the test description shown in Table 1. The results are shown in Table 2.

TABLE 2

| | | Composition (% by volume) | | | | |
|---|---|---|---|---|---|---|
| | | | | | | Calcium |
| | No. | PTFE R.R. ≦ 1000 | PTFE R.R. > 1000 | POB | Polyimide | phosphate |
| Example | 1 | Remainder | | 15 | | 10 |
| | 2 | Remainder | | 10 | | 10 |
| | 3 | Remainder | | 20 | | 10 |
| | 4 | Remainder | | 15 | | 2.5 |
| | 5 | Remainder | | 15 | | |
| | 6 | Remainder | | 15 | | |
| | 7 | Remainder | | 15 | | 10 |
| | 8 | | Remainder | 15 | | 10 |
| | 9 | | Remainder | 20 | | 10 |
| | 10 | | Remainder | 15 | | 10 |
| | 11 | | Remainder | 15 | | 10 |
| Comparative | 1 | Remainder | | | | 10 |
| Example | 2 | Remainder | | | 15 | 10 |
| | 3 | Remainder | | 30 | | 10 |
| | 4 | Remainder | | 15 | | |
| | 5 | Remainder | | 15 | | 10 |

| | | Composition (% by volume) | | | | | Abrasion | |
|---|---|---|---|---|---|---|---|---|
| | | Calcium | Magnesium | Barium | Molybdenum | | depth | Coefficient |
| | No. | pyrophosphate | pyrophosphate | sulfate | disulfide | Graphite | (μm) | of friction |
| Example | 1 | | | 10 | | | 31 | 0.121 |
| | 2 | | | 10 | | | 38 | 0.130 |
| | 3 | | | 10 | | | 36 | 0.142 |
| | 4 | | | 10 | | | 35 | 0.125 |
| | 5 | 10 | | 10 | | | 36 | 0.135 |
| | 6 | | 10 | 10 | | | 35 | 0.133 |
| | 7 | | | 5 | | | 34 | 0.132 |
| | 8 | | | 10 | | | 30 | 0.105 |
| | 9 | | | 10 | | | 32 | 0.110 |
| | 10 | | | 10 | 2.5 | | 25 | 0.097 |
| | 11 | | | 10 | | 2.5 | 28 | 0.105 |
| Comparative | 1 | | | 10 | | | 52 | 0.168 |
| Example | 2 | | | 10 | | | 45 | 0.178 |
| | 3 | | | 10 | | | 50 | 0.180 |
| | 4 | | | 10 | | | 48 | 0.193 |
| | 5 | | | | | | 55 | 0.178 |

In Table 2, Examples 1 to 7 illustrate those defined by invention according to aspects (1) and (2), Examples 8 and 9 illustrate those defined by invention according to aspects (1) to (3), and Examples 10 and 11 illustrate those defined by invention according to aspects (1) to (5). Comparative Example 1 is an example where no POB as the additional resin is added. Comparative Example 2 is an example where PI (polyimide resin) is added as the additional resin instead of POB. Comparative Example 3 is an example where POB is excessive. Comparative Example 4 is an example where no phosphate is included. Comparative Example 5 is an example where no barium sulfate is included.

First, when Examples 1 to 11 are compared with Comparative Examples 1 to 5, the abrasion depth and coefficient of friction in Examples 1 to 11 are both superior to those in Comparative Examples 1 to 5.

For more specific comparison, when Example 1 is compared with Comparative Example 1, the difference between them is only the presence of POB as the additional resin. From the test results of Example 1, in which POB is present, and Comparative Example 1, in which POB is absent, it can be understood that the abrasion depth and the coefficient of friction become far superior by adding POB as the additional resin to the sliding layer.

When Example 1 is compared with Comparative Example 2, they differ in that POB is added as the additional resin in Example 1, while PI is added as the additional resin in Comparative Example 2. It can be understood that the abrasion depth and the coefficient of friction become far superior by changing the additional resin from PI, which is a thermosetting resin, to POB, which is a thermoplastic resin called liquid crystal polymer. This is because no transferred film is formed on the counter material in Comparative Example 2, in which PI is added, while a transferred film is formed on the counter material in Example 1, in which POB is added.

When Example 1 is compared with Comparative Example 3, the difference between them is only the content of POB as the additional resin. With Example 1, in which the content of POB is within 10 to 20% by volume, which are desirable values, and Comparative Example 3, in which the content of POB is more than 25% by volume, which is the upper limit, it can be understood that if the content of POB as the additional resin is more than the appropriate values, the abrasion depth and the coefficient of friction are adversely affected.

When Example 1 is compared with Comparative Example 4, the difference between them is only the presence of phosphate. From the test results of Example 1, in which phosphate is present, and Comparative Example 4, in which phosphate is absent, it can be understood that the abrasion depth and the coefficient of friction become far superior by adding phosphate to the sliding layer.

Further, when Example 1 is compared with Comparative Example 5, the difference between them is only the presence of barium sulfate. From the test results of Example 1, in which barium sulfate is present, and Comparative Example 5, in which barium sulfate is absent, it can be understood that the abrasion depth and the coefficient of friction become far superior by adding barium sulfate to the sliding layer.

Now, comparisons among Examples 1 to 11 will be described. Examples 1 to 7 are the case where the value of R.R. is 1,000 or less, and Examples 8 to 11 are the case where the value of R.R. is more than 1,000. From their comparison, it can be understood that the case where the value of R.R. is more than 1,000 is slightly superior in both the abrasion depth and the coefficient of friction to the case where the value of R.R. is 1,000 or less.

For comparison of Examples 1 to 3, by changing the content of POB as the additional resin, the abrasion depth and the coefficient of friction also change slightly, but they are within the range that is sufficient for use even under the conditions of high PV values.

For comparison of Example 1 with Examples 4 to 6, Example 1 and Example 4 differ in the content of phosphate. Due to the difference, the abrasion depth and the coefficient of friction also change slightly, but they are within the range that is sufficient for use under the conditions of high PV values. For Examples 4, 5, and 6, the type of phosphate is changed, that is, calcium phosphate (Example 4), calcium pyrophosphate (Example 5), and magnesium pyrophosphate (Example 6) are used. The abrasion depth and the coefficient of friction are substantially the same among them, and from this, it can be understood that any of calcium phosphate, calcium pyrophosphate, and magnesium pyrophosphate may be used as phosphate. Of course, these types of phosphate may be mixed. It has been confirmed in another experiment that the abrasion depth and the coefficient of friction are substantially the same when magnesium phosphate is used as phosphate.

When Example 1 is compared with Example 7, the content of barium sulfate is different, so that the synergistic effect of barium sulfate and phosphate is slightly reduced in Example 7. It has been confirmed, however, that the abrasion depth and the coefficient of friction in Example 7 are substantially the same as those in Example 1.

When Examples 1 and 3 are compared with Examples 8 and 9 respectively, it can be understood that the difference in the R.R. of PTFE affects particularly a decrease in the coefficient of friction.

Further, when Example 1 is compared with Examples 10 and 11, it can be understood that the abrasion depth and the coefficient of friction both decrease by adding molybdenum disulfide or graphite as a solid lubricant. Molybdenum disulfide and graphite may be mixed and added.

1. A multilayer sliding member comprising:
a back metal;
a porous metal layer being formed on the back metal; and
a sliding layer impregnated into and coated on the porous metal layer, the sliding layer comprising 1 to 25% by volume of an oxybenzbyl polyester resin, 1 to 15% by volume of a phosphate, 1 to 20% by volume of barium sulfate, and a polytetrafluoroethylene resin.

2. The multilayer sliding member according to claim 1, wherein an average particle size of the oxybenzoyl polyester resin is from 5 to 30 μm.

3. The multilayer sliding member according to claim 1, wherein the polytetrafluoroethylene resin has a maximum reduction ratio of more than 1,000.

4. The multilayer sliding member according to claim 2, wherein the polytetrafluoroethylene resin has a maximum reduction ratio of more than 1,000.

5. The multilayer sliding member according to claim 1, wherein the phosphate comprises at least one selected from the group consisting of calcium phosphate, calcium pyrophosphate, magnesium phosphate, and magnesium pyrophosphate.

6. The multilayer sliding member according to claim 2, wherein the phosphate comprises at least one selected from the group consisting of calcium phosphate, calcium pyrophosphate, magnesium phosphate, and magnesium pyrophosphate.

7. The multilayer sliding member according to claim 3, wherein the phosphate comprises at least one selected from the group consisting of calcium phosphate, calcium pyrophosphate, magnesium phosphate, and magnesium pyrophosphate.

8. The multilayer sliding member according to claim 4, wherein the phosphate comprises at least one selected from the group consisting of calcium phosphate, calcium pyrophosphate, magnesium phosphate, and magnesium pyrophosphate.

9. The multilayer sliding member according to claim 1, wherein the sliding layer further contains 10% or less by volume of graphite or/and molybdenum disulfide.

10. The multilayer sliding member according to claim 2, wherein the sliding layer further contains 10% or less by volume of graphite or/and molybdenum disulfide.

11. The multilayer sliding member according to claim 3, wherein the sliding layer further contains 10% or less by volume of graphite or/and molybdenum disulfide.

12. The multilayer sliding member according to claim 4, wherein the sliding layer further contains 10% or less by volume of graphite or/and molybdenum disulfide.

13. The multilayer sliding member according to claim 5, wherein the sliding layer further contains 10% or less by volume of graphite or/and molybdenum disulfide.

14. The multilayer sliding member according to claim 6, wherein the sliding layer further contains 10% or less by volume of graphite or/and molybdenum disulfide.

15. The multilayer sliding member according to claim 7, wherein the sliding layer further contains 10% or less by volume of graphite or/and molybdenum disulfide.

16. The multilayer sliding member according to claim 8, wherein the sliding layer further contains 10% or less by volume of graphite or/and molybdenum disulfide.

17. The multilayer sliding member according to claim 1, wherein the sliding layer is substantially free of lead.

18. The multilayer sliding member according to claim 2, wherein the sliding layer is substantially free of lead.

19. The multilayer sliding member according to claim 4, wherein the sliding layer is substantially free of lead.

20. The multilayer sliding member according to claim 8, wherein the sliding layer is substantially free of lead.
